(19) United States
(12) Patent Application Publication
(10) Pub. No.: US 2024/0357525 A1
(43) Pub. Date: Oct. 24, 2024

(54) INFORMATION CONFIGURATION METHOD, INFORMATION CONFIGURATION APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/291,035

(22) PCT Filed: Jul. 23, 2021
(86) PCT No.: PCT/CN2021/108282

§ 371 Date: Jan. 22, 2024

(51) Int. Cl. H04W 56/00; H04W 72/044

(52) U.S. Cl. CPC H04W 56/0015; H04W 56/0035; H04W 72/044

(57) ABSTRACT

The present disclosure relates to information configuration methods, information configuration apparatuses and storage media. The information configuration method is performed by a terminal, and includes the following steps: acquiring first synchronization signal block SSB configuration information and/or a first system message; and determining second SSB configuration information based on the first SSB configuration information and/or the first system message; where the second SSB configuration information includes configuration information of one or more second SSB transmission parameters.

### CROSS-REFERENCE TO RELATED APPLICATION

The present application is a U.S. National Stage of International Application No. PCT/CN2021/108282, filed on Jul. 23, 2021, the contents of which are incorporated herein by reference in their entirety for all purposes.

### TECHNICAL FIELD

The present disclosure relates to the field of wireless communication technologies, and in particular to, information configuration methods, information configuration apparatuses and storage media.

### BACKGROUND

Generally, synchronization signals and a physical broadcast channel (which can be called as synchronization signal block, SSB) can be transmitted in a period. However, in the new generation communication system, the concept of multi-beam is introduced, so that SSBs can be transmitted based on multi-beam transmission. That is, the SSBs can be transmitted based on multi-beams in one period. Using multi-beam to transmit SSBs is also called SSB burst.

In a standalone scenario, a normal terminal generally blindly detects an SSB at potential frequency points. If an SSB is successfully detected, configuration information related to the SSB in a system message 1 (SIB1) corresponding to the SSB is acquired. If a reduced capability (RedCap) terminal is further introduced, how to determine the corresponding SSB configuration information is a problem that needs to be solved.

### SUMMARY

The present disclosure provides information configuration methods, information configuration apparatuses and storage media.

According to a first aspect of an embodiment of the present disclosure, an information configuration method is provided, which is performed by a terminal, and the method includes:
acquiring at least one of first synchronization signal block (SSB) configuration information or a first system message; and determining second SSB configuration information based on at least one of the first SSB configuration information or the first system message; where the second SSB configuration information includes configuration information of one or more second SSB transmission parameters.

According to a second aspect of an embodiment of the present disclosure, an information configuration method is provided, which is performed by a network device, and the method includes:
determining second SSB configuration information based on at least one of first SSB configuration information or a first system message, where the second SSB configuration information includes configuration information of one or more second SSB transmission parameters; and transmitting configuration information the first SSB configuration information or the first system message.

According to a third aspect of an embodiment of the present disclosure, an information configuration apparatus is provided, including:
a processor; a memory for storing executable instructions for the processor; where the processor is configured to: acquire at least one of first synchronization signal block (SSB) configuration information or a first system message; and determine second SSB configuration information based on at least one of the first SSB configuration information or the first system message; wherein the second SSB configuration information comprises configuration information of one or more second SSB transmission parameters.

It should be understood that the above general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a communication system architecture diagram between a network device and terminals according to an embodiment of the present disclosure.

FIG. 2 is a flowchart of an information configuration method according to an embodiment of the present disclosure.

FIG. 3 is a flowchart of another information configuration method according to an embodiment of the present disclosure.

FIG. 4 is a flowchart of another information configuration method according to an embodiment of the present disclosure.

FIG. 5 is a flowchart of another information configuration method according to an embodiment of the present disclosure.

FIG. 6 is a flowchart of another information configuration method according to an embodiment of the present disclosure.

FIG. 7 is a flowchart of another information configuration method according to an embodiment of the present disclosure.

FIG. 8 is a flowchart of another information configuration method according to an embodiment of the present disclosure.

FIG. 9 is a flowchart of another information configuration method according to an embodiment of the present disclosure.

FIG. 10 is a flowchart of another information configuration method according to an embodiment of the present disclosure.

FIG. 11 is a flowchart of another information configuration method according to an embodiment of the present disclosure.

FIG. 12 is a block diagram of an information configuration apparatus according to an embodiment of the present disclosure.

FIG. 13 is a block diagram of another information configuration apparatus according to an embodiment of the present disclosure.

FIG. 14 is a block diagram of an apparatus for information configuration according to an embodiment of the present disclosure.

FIG. 15 is a block diagram of another apparatus for information configuration according to an embodiment of the present disclosure.

### DETAILED DESCRIPTION

Reference will now be made in detail to embodiments, examples of which are illustrated in the accompanying drawings. When the following description refers to the accompanying drawings, unless otherwise indicated, the same numbers in different accompanying drawings indicate the same or similar elements. Embodiments described in the following embodiments do not represent all embodiments consistent with the present disclosure. Rather, they are merely examples of apparatuses and methods consistent with some aspects of the present disclosure as detailed in the appended claims.

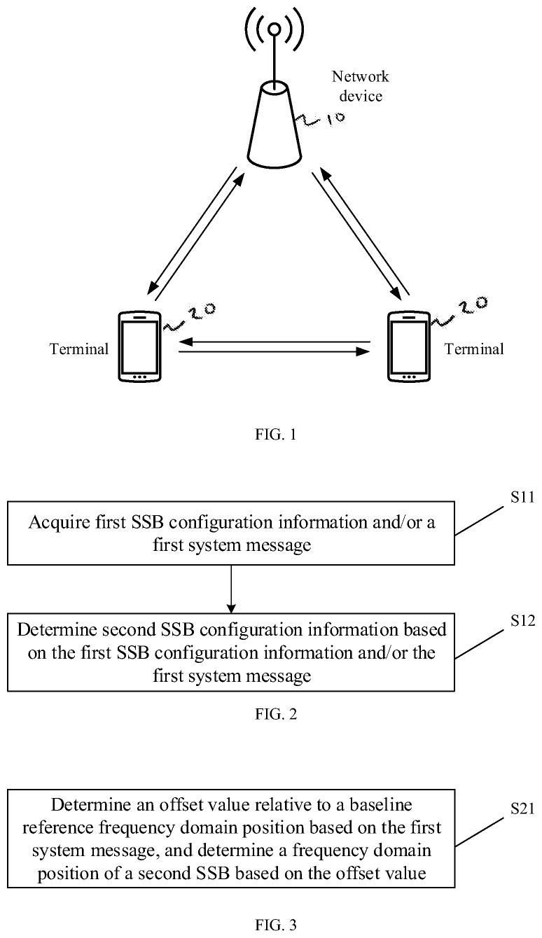

FIG. 1 is a communication system architecture diagram between a network device and terminals according to an embodiment of the present disclosure. The communication methods provided by the present disclosure may be applied in the communication system architecture diagram shown in FIG. 1. As shown in FIG. 1, a network-side device 10 may transmit signaling based on the architecture shown in FIG. 1

It can be understood that the communication system between a network device 10 and terminals 20 shown in FIG. 1 is only a schematic illustration, and other network devices may be included in the wireless communication system, such as a core network device, a wireless relay device, and a wireless backhaul device may also be included, which are not shown in FIG. 1. Embodiments of the present disclosure do not limit the number of network devices and the number of terminals included in the wireless communication system.

It can be further understood that the wireless communication system of the embodiments of the present disclosure is a network providing wireless communication functions. A wireless communication system can adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance, etc. According to factors such as capacity, speed, delay of different networks, networks can be divided into 2-Generation (2G) networks, 3G networks, 4G networks or future evolution networks, such as 5G networks, which can also be called new radio (NR) networks. For ease of description, the present disclosure sometimes refers to a wireless communication network simply as a network.

Furthermore, a network device involved in the present disclosure may also be referred to as a radio access network device. The wireless access network device may be: a base station, an evolved node B, a home base station, an access point (AP), a wireless relay node, a wireless return node, a transmission point (TRP) or a transmission and reception point (TRP), etc., in wireless fidelity (WIFI) system, and it may further be a gNodeB (gNB) in a NR system, or, it may further be a component or a part of a device that constitutes a base station, etc. When it is a vehicle networking (V2X) communication system, the network device can further be a vehicle-mounted device. It should be understood that in the embodiments of the present disclosure, there is no limitation on specific technologies and specific device forms adopted by the network device.

Furthermore, a terminal involved in the present disclosure, which may also be referred to as a terminal device, a user equipment (UE), a mobile station (MS), a mobile terminal (MT), etc., is a device that provides voice and/or data connectivity to a user, e.g., the terminal may be a hand-held device, a vehicle-mounted device, etc., having wireless connectivity. At present, some examples of terminals are: mobile phone, pocket personal computer (PPC), palmtop computer, personal digital assistant (PDA), notebook computer, tablet computer, wearable device, or vehicle-mounted device. In addition, when it is a vehicle networking (V2X) communication system, the terminal device can further be a vehicle-mounted device. It should be understood that the embodiments of the present disclosure do not limit specific technologies and specific device forms adopted by the terminal.

It should be understood that although terms first, second, third, etc. may be used to describe various information in the embodiments of the present disclosure, this information should not be limited to these terms. These terms are used only to distinguish the same type of information from one another. For example, without departing from the scope of the present disclosure, first information can also be called second information, and similarly, the second information can also be called the first information. Depending on the context, the word “if” as used herein can be interpreted as “at” or “when” or “in response to determining”.

Due to the vigorous development of Internet of Things, it has brought many conveniences to human life and work. Machine type communication (MTC) and narrow band Internet of Things (NB-IoT) are typical representatives of cellular IoT technology. At present, these technologies have been widely used in smart cities (such as meter reading), smart agriculture (such as temperature and humidity information collection) and smart transportation (such as shared-bikes).

In the communication system, for low rate and high delay scenarios (e.g., meter reading, environmental monitoring and other scenarios) in the IoT service, related art proposes two major technologies, MTC and NB-IoT. At present, NB-IoT technology can support a maximum rate of several hundred Kbps, and MTC can support a maximum rate of several Mbps. However, with the continuous development of IoT business (such as monitoring, smart home, wearable devices, and industrial sensor detection), a speed of tens to 100 Mbps is generally required, and requirements for delay are also relatively high. Therefore, in the communication system, MTC and NB-IoT can no longer meet the requirements of the current Internet of Things service. At the same time, on the other hand, MTC and NB-IoT technologies are generally deployed in basements, outdoor and other scenes where it is not easy to charge or replace batteries, so a terminal associated with MTC and NB-IoT technologies is limited by hardware, which leads to its coverage capacity is not as good as that of general wireless communication terminals. And due to the impact of the application environment, the power saving of its equipment is also a characteristic of MTC and NB IoT technologies. Based on this situation, the requirement of designing another new user equipment in 5G NR to cover this mid-range IoT device has begun to be proposed. In a current 3rd Generation Partnership Project (3GPP) standardization, this new terminal type is called a Redcap terminal or NR-lite for short.

In a traditional communication technology, such as a Long Term Evolution (LTE) system, synchronization signals and a broadcast channel can be transmitted in a period. With the development of communication technology, the concept of multi-beam is introduced in the new generation of communication technology, such as NR system. Therefore, SSBs can be transmitted based on multi-beam transmission, that is, an SSB set can be transmitted based on different beams in one period, which can also be called SSB burst. In general, for example, in a standalone scenario, the terminal usually blindly detects an SSB at potential frequency points.

When an SSB is successfully detected, SIB1 corresponding to the SSB will inform a configuration of whole SSB, including a transmission period of SSB and an SSB pattern in the SSB burst. At the same time, an SSB index of the SSB in the whole SSB burst can be obtained in a system message (a master information block, MIB) of the detected SSB.

As in the above embodiment, the Redcap terminal is further introduced into the new generation communication technology. If SSBs are transmitted based on multi-beam, how to determine the SSB(s) for the Redcap terminal needs further configuration determination. Based on this, the present disclosure provides an information configuration method, which adds one or more SSBs corresponding to the RedCap terminal to SSBs of a non-RedCap terminal, thus solving the problem of configuring special SSB(s) for the RedCap terminal.

FIG. 2 is a flowchart of an information configuration method according to an embodiment of the present disclosure. As shown in FIG. 2, the information configuration method is used in a terminal and includes the following steps.

At step S11, first SSB configuration information and/or a first system message are acquired.

At step S12, second SSB configuration information is determined based on the first SSB configuration information and/or the first system message.

In an embodiment of the present disclosure, the first SSB configuration information and the second SSB configuration information are used in different types of terminals, while a first SSB can be monitored by all types of terminals and a second SSB can be monitored by terminals with relatively low communication ability.

In an embodiment of the present disclosure, the terminal first acquires a first SSB, which is carried in an initial downlink bandwidth part (BWP) corresponding to the first SSB.

For ease of differentiation, the present disclosure refers to an initial downlink BWP corresponding to the first SSB as a first initial downlink BWP and an initial downlink BWP corresponding to the second SSB as a second initial downlink BWP.

In an embodiment of the present disclosure, the terminal can be a terminal with relatively low communication capability, such as a RedCap terminal, which can also be applied to other terminals. The following embodiments of the present disclosure will be explained using a RedCap terminal, but not limited to this terminal.

The terminal acquires the first SSB configuration information, determines the first initial downlink BWP, and determines a common physical downlink control channel (PDCCH) on the first initial downlink BWP. Then the terminal reads a system message corresponding to the first SSB scheduled by the common PDCCH, for example, it can be SIB (system information block) or referred to as the first system message. Further based on the first SSB configuration information and/or the first system message, the second SSB configuration information is acquired.

The second SSB configuration information includes configuration information of second SSB transmission parameters, for example, the second SSB configuration information may correspond to the RedCap terminal.

According to the information configuration method provided by the embodiments of the present disclosure, different types of terminals (for example, RedCap terminals) can be configured with corresponding SSBs, and a way for different types of terminals to acquire corresponding SSB configuration information is further proposed, thus solving the problem of how to configure SSBs for different types of terminals.

In some embodiments of the present disclosure, the second SSB configuration information includes at least one of the following:
a frequency domain resource of a second SSB;
a time domain resource of the second SSB; or
a beam for transmitting the second SSB.

In an embodiment of the present disclosure, in response to the second SSB configuration information including the frequency domain resource of the second SSB, as shown in FIG. 3, the frequency domain resource of the second SSB can be determined in the following manner as shown in FIG. 3.

At step S21, an offset value relative to a baseline reference frequency domain position is determined based on the first system message, and a frequency domain position of a second SSB is determined based on the offset value.

In some embodiments of the present disclosure, the terminal acquires the first SSB and acquires the first system message scheduled by the common PDCCH based on the first SSB. The first system message carries the configuration information of the second SSB, and if the configuration information includes a frequency domain position of the second SSB, the terminal acquires the offset value relative to the baseline reference frequency domain position based on the first system message scheduled by the common PDCCH. The baseline reference frequency domain position is determined based on a protocol or determined based on a rule, where the rule can be predefined. The baseline reference frequency domain position can further be determined based on the first SSB, or the reference frequency domain position can further be determined based on the first initial downlink BWP.

The terminal determines the frequency domain position of the second SSB based on the determined offset and the baseline reference frequency domain position.

In some embodiments of the present disclosure, time domain information of the second SSB can further be determined in the first system message, where the time domain information of the second SSB includes a period of the second SSB, the number of SSBs contained in one SSB burst for the second SSB, and the like.

In an embodiment of the present disclosure, the first system message may further include a frequency domain position of the initial downlink BWP corresponding to the second SSB.

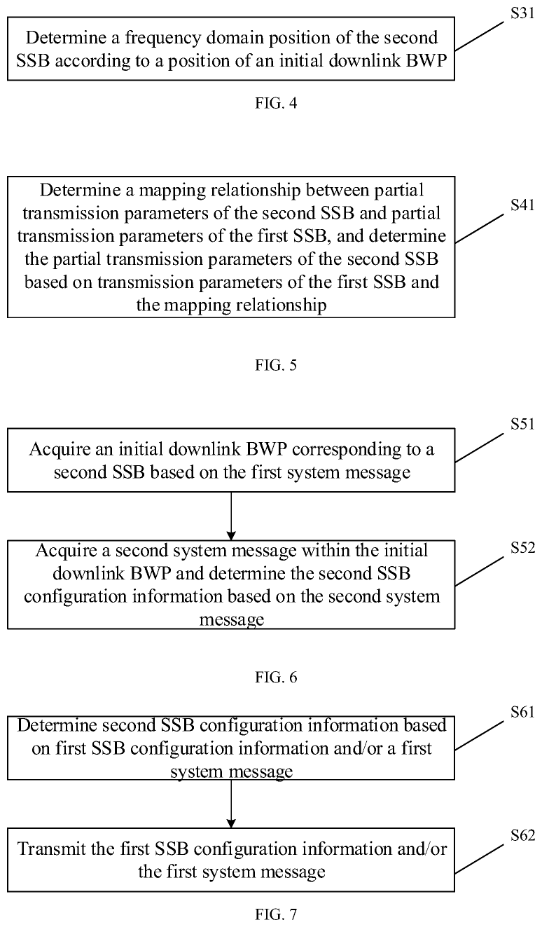

In an embodiment of the present disclosure, in response to the second SSB configuration information including the frequency domain resource of the second SSB, as shown in FIG. 4, the frequency domain resource of the second SSB can be determined in the following manner as shown in FIG. 4. At step S31, a frequency domain position of the second SSB is determined according to a position of an initial downlink BWP.

In an embodiment of the present disclosure, the terminal determines the first system message scheduled by the common PDCCH, and acquires a position of the initial downlink BWP corresponding to the second SSB (e.g., the second initial downlink BWP) and indication information via the first system message, where the indication information is used to indicate a position of the second SSB in the corresponding initial downlink BWP. The position of the second initial downlink BWP can further be determined based on a protocol or determined based on a rule, where the rule can be predefined.

In an embodiment of the present disclosure, in response to determining the second SSB configuration information based on the first SSB configuration information and the first system message, as shown in FIG. 5, the second SSB configuration information can further be determined in the following manner. At step S41, a mapping relationship between partial transmission parameters of the second SSB and partial transmission parameters of the first SSB is determined, and the partial transmission parameters of the second SSB is determined based on the transmission parameters of the first SSB and the mapping relationship.

In some embodiments of the present disclosure, the partial transmission parameters of the second SSB determined based on the mapping relationship include at least one of the following:
a time domain position for transmitting the second SSB;
a transmission period of the second SSB;
a number of SSBs contained in one SSB burst for the second SSB; or
beam information used by the second SSB.

In some embodiments of the present disclosure, if the configuration information of the first SSB and the configuration information of the second SSB are partially the same, for example, one or more of the above partial transmission parameters are same, the mapping relationship between partial transmission parameters of the second SSB and partial transmission parameters of the first SSB can be determined based on communication rules. The rules can be predefined rules.

Part of the configuration information for the second SSB is determined in the first SSB configuration information based on the mapping relationship. The mapping relationship includes the partial transmission parameters for the second SSB are same as the partial transmission parameters for the first SSB. That is, the same partial transmission parameters as those for the second SSB are determined in the first SSB configuration information.

In an embodiment of the present disclosure, remaining second SSB configuration information except the partial configuration information can be acquired in the following manner.

The terminal can acquire the first SSB and acquire the first system message scheduled by the common PDCCH based on the first SSB, and based on information carried by the first system message, the terminal can determine remaining transmission parameters of the second SSB other than the partial transmission parameters determined based on the first SSB configuration information. The remaining transmission parameters other than the partial transmission parameters determined based on the first SSB configuration information may be transmission parameters such as a frequency of the second SSB.

In an embodiment of the present disclosure, in response to determining the second SSB configuration information based on the first SSB configuration information and the first system message, as shown in FIG. 6, the second SSB configuration information can further be determined in the following manner. At step S51, an initial downlink BWP corresponding to a second SSB is acquired based on the first system message.

At step S52, a second system message is acquired within the initial downlink BWP and the second SSB configuration information is determined based on the second system message.

In some embodiments of the present disclosure, the terminal acquires the first SSB, determines the first initial downlink BWP, reads the first system message scheduled by the common PDCCH via the common PDCCH carried on the first initial downlink BWP, and acquires the second initial downlink BWP corresponding to the second SSB in the first system message. In the second initial downlink BWP corresponding to the second SSB, a second system message is acquired, where the second system message may be carried in the PDCCH and PDSCH.

Acquiring the configuration information of the second SSB in the second system message may include: a period of the second SSB, the number of SSBs contained in one SSB burst for the second SSB, and the like.

Based on the same/similar concept, embodiments of the present disclosure further provide an information configuration method.

FIG. 7 is a flowchart of an information configuration method according to an embodiment of the present disclosure. As shown in FIG. 7, the information configuration method is used in a network device and includes the following steps.

At step S61, second SSB configuration information is determined based on first SSB configuration information and/or a first system message.

The second SSB configuration information includes configuration information of one or more second SSB transmission parameters.

At step S62, the first SSB configuration information and/or the first system message are transmitted.

In an embodiment of the present disclosure, the first SSB configuration information and the second SSB configuration information are respectively used in different types of terminals, while a first SSB can be monitored by all types of terminals and a second SSB can be monitored by terminals with relatively low communication ability.

In an embodiment of the present disclosure, the network device determines a first SSB, which is carried in an initial BWP corresponding to the first SSB. For ease of differentiation, the present disclosure refers to an initial downlink BWP corresponding to the first SSB as a first initial downlink BWP and an initial downlink BWP corresponding to the second SSB as a second initial downlink BWP.

In an embodiment of the present disclosure, the second SSB and the configuration information of the second SSB configured by a network device may be directed at terminals with relatively low communication capability, such as a RedCap terminal, but there may be other terminals. The following embodiments of the present disclosure will be explained using a RedCap terminal, but not limited to this terminal.

The network device determines first SSB configuration information, determines a first initial downlink BWP, and determines a common PDCCH on the first initial downlink BWP. The network device determines a system message corresponding to the first SSB scheduled by the common PDCCH, the system message may be, for example, a system information block (SIB), which may also be referred to as a first system message. Further based on the first SSB configuration information and/or the first system message, the network device configures the second SSB configuration information.

The second SSB configuration information includes configuration information of second SSB transmission parameters, for example, the second SSB configuration information may correspond to the RedCap terminal.

According to the information configuration method provided by the embodiments of the present disclosure, different types of terminals (for example, RedCap terminals) can be configured with corresponding SSBs, and a way for different types of terminals to acquire corresponding SSB configuration information is further proposed, thus solving the problem of how to configure SSBs for different types of terminals.

In some embodiments of the present disclosure, the second SSB configuration information includes at least one of the following:
a frequency domain resource of a second SSB;
a time domain resource of the second SSB; or
a beam for transmitting the second SSB.

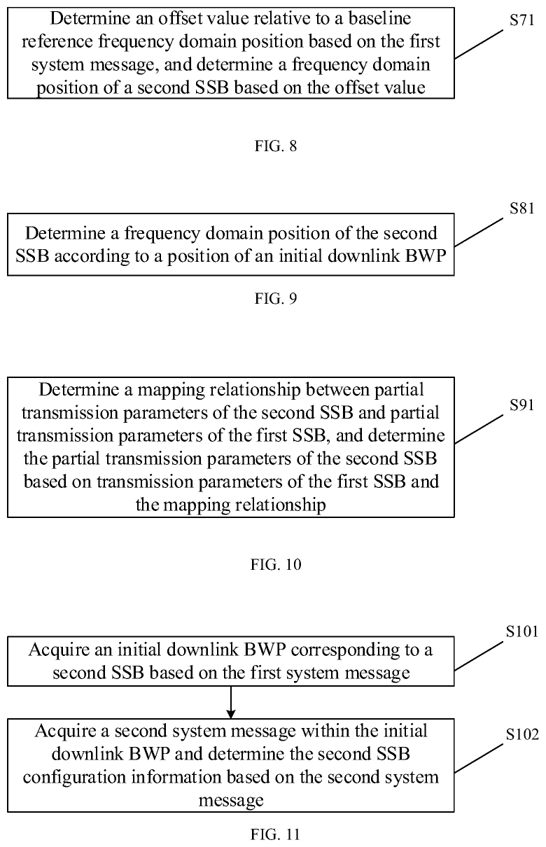

In an embodiment of the present disclosure, in response to the second SSB configuration information including the frequency domain resource of the second SSB, as shown in FIG. 8, the frequency domain resource of the second SSB can be configured to the terminal in the following manner as shown in FIG. 8. At step S71, an offset value relative to a baseline reference frequency domain position is determined based on the first system message, and a frequency domain position of a second SSB is determined based on the offset value.

In some embodiments of the present disclosure, the network device determines the first SSB and determines the first system message scheduled by the common PDCCH based on the first SSB. In the first system message, configure the configuration information of the second SSB. If the configuration information includes a frequency domain position of the second SSB, the network device configures an offset value relative to the baseline reference frequency domain position based on the first system message scheduled by the common PDCCH. The baseline reference frequency domain position is determine based on a protocol or determine based on a rule, where the rule can be predefined. The baseline reference frequency domain position can further be determined based on the first SSB, or the reference frequency domain position can further be determined based on the first initial downlink BWP.

The terminal can determine the frequency domain position of the second SSB based on the determined offset and the baseline reference frequency domain position.

In some embodiments of the present disclosure, the network device may further configure time domain information of the second SSB in the first system message, where the time domain information of the second SSB includes a period of the second SSB, the number of SSBs contained for one SSB burst in the second SSB, and the like.

In an embodiment of the present disclosure, the network device may further include a frequency domain position of the initial downlink BWP corresponding to the second SSB in the first system message.

In an embodiment of the present disclosure, in response to the second SSB configuration information including the frequency domain resource of the second SSB, as shown in FIG. 9, for the frequency domain resource of the second SSB, the network device can further determine the frequency domain resource of the second SSB of the terminal by the following way as shown in FIG. 9. At step S81, a frequency domain position of the second SSB is determined according to a position of an initial downlink BWP.

In an embodiment of the present disclosure, the network device determines the first system message scheduled by the common PDCCH, and configures a position of the initial downlink BWP corresponding to the second SSB (e.g., the second initial downlink BWP) and indication information via the first system message, where the indication information is used to indicate a position of the second SSB in the corresponding initial downlink BWP. The position of the second initial downlink BWP can further be determined based on a protocol or determined based on a rule, where the rule can be predefined.

In an embodiment of the present disclosure, in response to determining the second SSB configuration information for the terminal based on the first SSB configuration information and the first system message, as shown in FIG. 10, the network device can further determine the second SSB configuration information in the following manner.

At step S91, a mapping relationship between partial transmission parameters of the second SSB and partial transmission parameters of the first SSB is determined, and the partial transmission parameters of the second SSB is determined based on the transmission parameters of the first SSB and the mapping relationship.

In some embodiments of the present disclosure, the partial transmission parameters of the second SSB determined based on the mapping relationship include at least one of the following:
a time domain position for transmitting the second SSB;
a transmission period of the second SSB;
a number of SSBs contained in one SSB burst for the second SSB; or
beam information used by the second SSB.

In some embodiments of the present disclosure, if the configuration information of the first SSB and the configuration information of the second SSB are partially the same, for example, one or more of the above partial transmission parameters are same, the mapping relationship between partial transmission parameters of the second SSB and partial transmission parameters of the first SSB can be determined based on communication rules. The rules can be predefined rules.

Part of the configuration information for the second SSB is determined in the first SSB configuration information based on the mapping relationship. The mapping relationship includes the partial transmission parameters for the second SSB are same as the partial transmission parameters for the first SSB. That is, the same partial transmission parameters as those for the second SSB are determined in the first SSB configuration information.

In an embodiment of the present disclosure, the network device can configure remaining second SSB configuration information except the partial configuration information in the following manner.

The network device can determine the first SSB and determine the first system message scheduled by the common PDCCH based on the first SSB, and based on information carried by the first system message, the network device can configure remaining transmission parameters of the second SSB other than the partial transmission parameters determined based on the first SSB configuration information. The remaining transmission parameters other than the partial transmission parameters determined based on the first SSB configuration information may be transmission parameters such as a frequency of the second SSB.

In an embodiment of the present disclosure, in response to determining the second SSB configuration information based on the first SSB configuration information and the first system message, as shown in FIG. 11, the network device can further determine the second SSB configuration information in the following manner. At step S101, an initial downlink BWP corresponding to a second SSB is acquired based on the first system message.

At step S102, a second system message is acquired within the initial downlink BWP and the second SSB configuration information is determined based on the second system message.

In some embodiments of the present disclosure, the network device determines the first SSB, determines the first initial downlink BWP, determines the first system message scheduled by the common PDCCH via the common PDCCH carried on the first initial downlink BWP, and configures the second initial downlink BWP corresponding to the second SSB in the first system message. In the second initial downlink BWP corresponding to the second SSB, a second system message is configured, where the second system message may be carried in the PDCCH and PDCCH.

The configuration information of the second SSB configured by the network device in the second system message may include: a period of the second SSB, the number of SSBs contained for one SSB burst in the second SSB, and the like.

Based on the same concept, embodiments of the present disclosure further provide an information configuration apparatus.

It can be understood that, in order to realize the above functions, the information configuration apparatus provided by the embodiments of the present disclosure includes corresponding hardware structures and/or software modules for performing various functions.

Combining the units and algorithm steps of various examples in embodiments of the present disclosure, the embodiments of the present disclosure can be realized in the form of hardware or a combination of hardware and computer software. Whether a function is executed by hardware or computer software drives hardware depends on the specific application and design constraints of the technical solution. Those skilled in the art can use different methods to realize the described functions for each specific application, but such implementation should not be considered beyond the scope of the technical solution of the embodiments of the present disclosure.

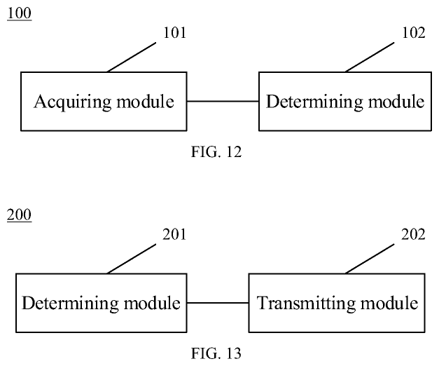

FIG. 12 is a block diagram of an information configuration apparatus according to an embodiment of the present disclosure. Referring to FIG. 12, the information configuration apparatus 100, which is applied to a terminal, includes an acquiring module 101 and a determining module 102.

The acquiring module 101 is configured to acquire first synchronization signal block SSB configuration information and/or a first system message. The determining module 102 is configured to determine second SSB configuration information based on the first SSB configuration information and/or the first system message. The second SSB configuration information includes configuration information of one or more second SSB transmission parameters.

In an embodiment of the present disclosure, the second SSB configuration information includes at least one of the following:
a frequency domain resource of a second SSB;
a time domain resource of the second SSB; or
a beam for transmitting the second SSB.

In an embodiment of the present disclosure, the determining module 102 is configured to determine an offset value relative to a baseline reference frequency domain position based on the first system message, and determine a frequency domain position of a second SSB based on the offset value.

In an embodiment of the present disclosure, the first system message includes a frequency domain position of the initial downlink bandwidth part (BWP) corresponding to the second SSB.

The determining module 102 is configured to determine a frequency domain position of the second SSB according to a position of an initial downlink BWP.

In an embodiment of the present disclosure, the determining module 102 is configured to determine a mapping relationship between partial transmission parameters of the second SSB and partial transmission parameters of the first SSB, and determine the partial transmission parameters of the second SSB based on transmission parameters of the first SSB and the mapping relationship.

In an embodiment of the present disclosure, the partial transmission parameters of the second SSB determined based on the mapping relationship include at least one of the following:
a time domain position for transmitting the second SSB;
a transmission period of the second SSB;
a number of SSBs contained in one SSB burst for the second SSB; or
beam information used by the second SSB.

In an embodiment of the present disclosure, the mapping relationship includes the partial transmission parameters of the second SSB are same as the partial transmission parameters of the first SSB.

In an embodiment of the present disclosure, the determining module 102 is further configured to determine, based on the first system message, remaining transmission parameters except the partial transmission parameters determined based on the first SSB configuration information.

In an embodiment of the present disclosure, the determining module 102 is configured to acquire an initial downlink BWP corresponding to a second SSB based on the first system message, acquire a second system message within the initial downlink BWP and determine the second SSB configuration information based on the second system message.

FIG. 13 is a block diagram of an information configuration apparatus according to an embodiment of the present disclosure. Referring to FIG. 13, the information configuration apparatus 200, which is applied to a network device, includes a determining module 201 and a transmitting module 202.

The determining module 201 is configured to determine second SSB configuration information based on first SSB configuration information and/or a first system message. The second SSB configuration information includes configuration information of one or more second SSB transmission parameters. The transmitting module 202 is configured to transmit the first synchronization signal block (SSB) configuration information and/or the first system message.

In an embodiment of the present disclosure, the second SSB configuration information includes at least one of the following:
a frequency domain resource of a second SSB;
a time domain resource of the second SSB; or
a beam for transmitting the second SSB.

In an embodiment of the present disclosure, the determining module 201 is configured to determine an offset value relative to a baseline reference frequency domain position based on the first system message, and determine a frequency domain position of a second SSB based on the offset value.

In an embodiment of the present disclosure, the first system message includes a frequency domain position of the initial downlink bandwidth part (BWP) corresponding to the second SSB.

The determining module 201 is configured to determine a frequency domain position of the second SSB according to a position of an initial downlink BWP.

In an embodiment of the present disclosure, the determining module 201 is configured to determine a mapping relationship between partial transmission parameters of the second SSB and partial transmission parameters of the first SSB, and determine the partial transmission parameters of the second SSB based on transmission parameters of the first SSB and the mapping relationship.

In an embodiment of the present disclosure, the partial transmission parameters include at least one of the following:
a time domain position for transmitting the second SSB;
a transmission period of the second SSB;
a number of SSBs contained in one SSB burst for the second SSB; or
beam information used by the second SSB.

In an embodiment of the present disclosure, the mapping relationship includes the partial transmission parameters of the second SSB are same as the partial transmission parameters of the first SSB.

In an embodiment of the present disclosure, the determining module 201 is further configured to determine, based on the first system message, remaining transmission parameters except the partial transmission parameters determined based on the first SSB configuration information.

In an embodiment of the present disclosure, the determining module 201 is configured to acquire an initial downlink BWP corresponding to a second SSB based on the first system message, acquire a second system message within the initial downlink BWP and determine the second SSB configuration information based on the second system message.

Regarding to the apparatus in the above embodiment, a specific way in which each module performs operations has been described in detail in the embodiments relating to the method, and will not be described in detail here.

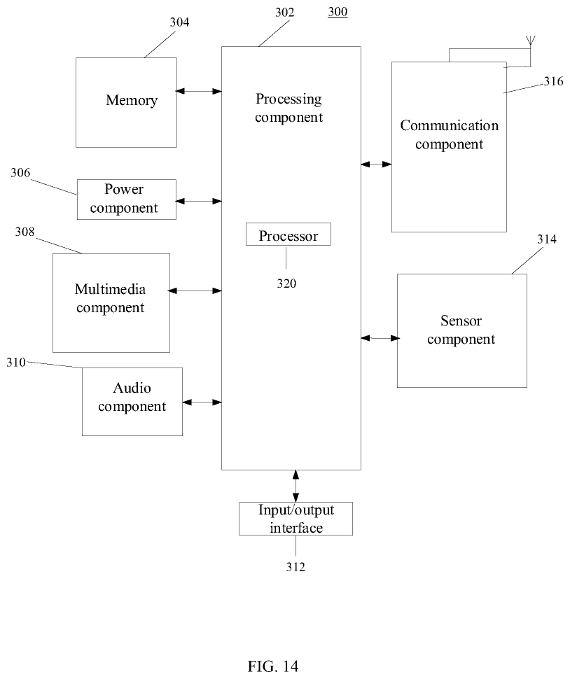

FIG. 14 is a block diagram of an apparatus 300 for information configuration according to an embodiment of the present disclosure. For example, the apparatus 300 may be a mobile phone, a computer, a digital broadcasting terminal, a messaging device, a game console, a tablet device, a medical device, a fitness device, a personal digital assistant, etc.

Referring to FIG. 14, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 generally controls the overall operation of the apparatus 300, such as operations associated with display, telephone call, data communication, camera operation and recording operation. The processing component 302 may include one or more processors 320 to execute instructions to complete all or part of steps of the above-mentioned method. In addition, the processing component 302 may include one or more modules to facilitate interactions between the processing component 302 and other components. For example, the processing component 302 may include a multimedia module to facilitate interactions between the multimedia component 308 and the processing component 302.

The memory 304 is configured to store various types of data to support operations in the apparatus 300. Examples of these data include instructions of any application program or method for being operated on the apparatus 300, contact data, phone book data, messages, pictures, videos, etc. The memory 304 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 306 provides power to various components of the apparatus 300. The power component 306 may include a power management system, one or more power supplies, and other components associated with generating, managing and distributing power for the apparatus 300.

The multimedia component 308 includes a screen that provides an output interface between the apparatus 300 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 308 includes a front camera and/or a rear camera. When the apparatus 300 is in an operation mode, such as a shooting mode or a video mode, the front camera and/or the rear camera can receive external multimedia data. Each front camera and rear camera may be a fixed optical lens system or have focal length and optical zoom capability.

The audio component 310 is configured to output and/or input audio signals. For example, the audio component 310 includes a microphone (MIC) configured to receive external audio signals when the apparatus 300 is in the operation mode, such as a calling mode, a recording mode and a voice recognition mode. The received audio signal may be further stored in the memory 304 or transmitted via the communication component 316. In some embodiments, the audio component 310 further includes a speaker for outputting audio signals.

The I/O interface 312 provides an interface between the processing component 302 and peripheral interface modules, where the peripheral interface modules may be keyboards, click-wheels, buttons, etc. These buttons may include, but are not limited to: home button, volume button, start button and lock button.

The sensor component 314 includes one or more sensors for providing various aspects of state evaluation for the apparatus 300. For example, the sensor component 314 can detect an on/off state of the apparatus 300, a relative positioning of components, for example, the components are the display and the keypad of the apparatus 300, and the sensor component 314 can also detect a position change of the apparatus 300 or a component of the apparatus 300, presence or absence of user contact with the apparatus 300, orientation or acceleration/deceleration of the apparatus 300 and a temperature change of the apparatus 300.

The sensor component 314 may include a proximity sensor configured to detect presence of a nearby object without any physical contact. The sensor component 314 may also include an optical sensor, such as a CMOS or CCD image sensor, for use in imaging applications. In some embodiments, the sensor component 314 may further include an acceleration sensor, a gyroscope sensor, a magnetic sensor, a pressure sensor or a temperature sensor.

The communication component 316 is configured to facilitate wired or wireless communication between the apparatus 300 and other devices. The apparatus 300 can access a wireless network based on communication standards, such as WiFi, 2G or 3G, or combinations thereof. In an embodiment of the present disclosure, the communication component 316 receives a broadcast signal or broadcast related information from an external broadcast management system via a broadcast channel. In an embodiment of the present disclosure, the communication component 316 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the apparatus 300 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 304 including instructions, where the instructions can be executed by a processor 320 of the apparatus 300 to complete the above-mentioned delay determination method. For example, the non-transitory computer-readable storage medium may be an ROM, a random access memory (RAM), a CD-ROM, a magnetic tape, a floppy disk, an optical data storage device, etc.

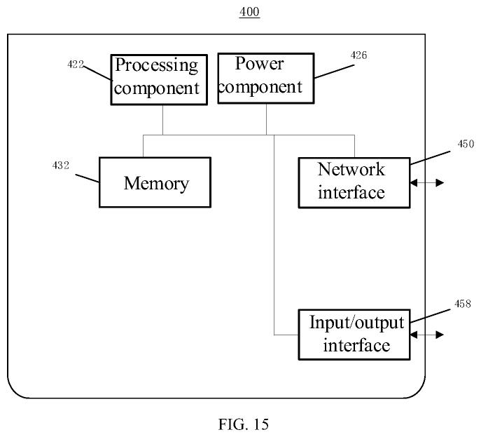

FIG. 15 is a block diagram of an apparatus 400 for information configuration according to an embodiment of the present disclosure. For example, the apparatus 400 may be provided as a server. Referring to FIG. 15, the apparatus 400 includes a processing component 422, which further includes one or more processors, and memory resources represented by a memory 432 for storing instructions that can be executed by the processing component 422, such as application programs. An application program stored in the memory 432 may include one or more modules each corresponding to a set of instructions. In addition, the processing component 422 is configured to execute instructions to perform the method described above.

The apparatus 400 may further include a power component 426 configured to perform power management of the apparatus 400, a wired or wireless network interface 450 configured to connect the apparatus 400 to a network, and an input-output (I/O) interface 458. The apparatus 400 can operate based on an operating system stored in the memory 432, such as Windows Server™, Mac OS X™, Unix™, Linux™, FreeBSD™ or the like.

According to a first aspect of an embodiment of the present disclosure, an information configuration method is provided, which is performed by a terminal, and the method includes:
acquiring first synchronization signal block (SSB) configuration information and/or a first system message; and determining second SSB configuration information based on the first SSB configuration information and/or the first system message; where the second SSB configuration information includes configuration information of one or more second SSB transmission parameters.

In an implementation, the second SSB configuration information includes at least one of the following:
a frequency domain resource of a second SSB;
a time domain resource of the second SSB; or
a beam for transmitting the second SSB.

In an implementation, determining the second SSB configuration information based on the first SSB configuration information and/or the first system message includes:
determining an offset value relative to a baseline reference frequency domain position based on the first system message, and determining a frequency domain position of a second SSB based on the offset value.

In an implementation, the first system message includes a frequency domain position of the initial downlink bandwidth part (BWP) corresponding to a second SSB; and
determining the second SSB configuration information based on the first SSB configuration information and/or the first system message includes:
determining a frequency domain position of the second SSB according to the frequency domain position of the initial downlink BWP.

In an implementation, determining the second SSB configuration information based on the first SSB configuration information and/or the first system message includes:
determining a mapping relationship between partial transmission parameters of the second SSB and partial transmission parameters of the first SSB, and determining the partial transmission parameters of the second SSB based on transmission parameters of the first SSB and the mapping relationship.

In an implementation, the partial transmission parameters of the second SSB determined based on the mapping relationship include at least one of the following:
a time domain position for transmitting the second SSB;
a transmission period of the second SSB;
a number of SSBs contained in one SSB burst for the second SSB; or
beam information used by the second SSB.

In an implementation, the mapping relationship includes the partial transmission parameters of the second SSB are same as the partial transmission parameters of the first SSB.

In an implementation, determining the second SSB configuration information based on the first SSB configuration information and/or the first system message further includes:
determining, based on the first system message, remaining transmission parameters except the partial transmission parameters determined based on the first SSB configuration information.

In an implementation, determining the second SSB configuration information based on the first SSB configuration information and/or the first system message includes:
acquiring an initial downlink BWP corresponding to a second SSB based on the first system message, acquiring a second system message within the initial downlink BWP; and determining the second SSB configuration information based on the second system message.

According to a second aspect of an embodiment of the present disclosure, an information configuration method is provided, which is performed by a network device, and the method includes:
determining second SSB configuration information based on first SSB configuration information and/or a first system message, where the second SSB configuration information includes configuration information of one or more second SSB transmission parameters; and transmitting the first SSB configuration information and/or the first system message.

In an implementation, the second SSB configuration information includes at least one of the following:
a frequency domain resource of a second SSB;
a time domain resource of the second SSB; or
a beam for transmitting the second SSB.

In an implementation, determining the second SSB configuration information based on the first SSB configuration information and/or the first system message includes:
determining an offset value relative to a baseline reference frequency domain position based on the first system message, and determining a frequency domain position of a second SSB based on the offset value.

In an implementation, the first system message includes a frequency domain position of the initial downlink bandwidth part (BWP) corresponding to the second SSB; and
determining the second SSB configuration information based on the first SSB configuration information and/or the first system message includes:
determining a frequency domain position of the second SSB according to the frequency domain position of the initial downlink BWP.

In an implementation, determining the second SSB configuration information based on the first SSB configuration information and/or the first system message includes:
determining a mapping relationship between partial transmission parameters of the second SSB and partial transmission parameters of the first SSB, and determining the partial transmission parameters of the second SSB based on transmission parameters of the first SSB and the mapping relationship.

In an implementation, the partial transmission parameters of the second SSB include at least one of the following:
a time domain position for transmitting the second SSB;
a transmission period of the second SSB;
a number of SSBs contained in one SSB burst for the second SSB; or
beam information used by the second SSB.

In an implementation, the mapping relationship includes the partial transmission parameters of the second SSB are same as the partial transmission parameters of the first SSB.

In an implementation, determining the second SSB configuration information based on the first SSB configuration information and/or the first system message further includes:
determining, based on the first system message, remaining transmission parameters except the partial transmission parameters determined based on the first SSB configuration information.

In an implementation, determining the second SSB configuration information based on the first SSB configuration information and/or the first system message further includes:
acquiring an initial downlink BWP corresponding to a second SSB based on the first system message, and acquiring a second system message within the initial downlink BWP; and determining the second SSB configuration information based on the second system message.

According to a third aspect of an embodiment of the present disclosure, an information configuration apparatus is provided, which is performed by a terminal, and the apparatus includes:
an acquiring module, configured to acquire first synchronization signal block SSB configuration information and/or a first system message; and a determining module, configured to determine second SSB configuration information based on the first SSB configuration information and/or the first system message; where the second SSB configuration information includes configuration information of one or more second SSB transmission parameters.

In an implementation, the second SSB configuration information includes at least one of the following:
a frequency domain resource of a second SSB;
a time domain resource of the second SSB; or
a beam for transmitting the second SSB.

In an implementation, the determining module is configured to:
determining an offset value relative to a baseline reference frequency domain position based on the first system message, and determining a frequency domain position of a second SSB based on the offset value.

In an implementation, the first system message includes a frequency domain position of the initial downlink bandwidth part (BWP) corresponding to the second SSB; and
the determining module is configured to:
determine a frequency domain position of the second SSB according to the frequency domain position of the initial downlink BWP.

In an implementation, the determining module is configured to:
determine a mapping relationship between partial transmission parameters of the second SSB and partial transmission parameters of the first SSB, and determine the partial transmission parameters of the second SSB based on transmission parameters of the first SSB and the mapping relationship.

In an implementation, the partial transmission parameters of the second SSB determined based on the mapping relationship include at least one of the following:
a time domain position for transmitting the second SSB;
a transmission period of the second SSB;
a number of SSBs contained in one SSB burst for the second SSB; or
beam information used by the second SSB.

In an implementation, the mapping relationship includes the partial transmission parameters of the second SSB are same as the partial transmission parameters of the first SSB.

In an implementation, the determining module is further configured to:
determine, based on the first system message, remaining transmission parameters except the partial transmission parameters determined based on the first SSB configuration information.

In an implementation, the determining module is configured to:
acquire an initial downlink BWP corresponding to a second SSB based on the first system message, acquire a second system message within the initial downlink BWP; and determining the second SSB configuration information based on the second system message.

According to a fourth aspect of the embodiment of the present disclosure, an information configuration apparatus is provided, which is performed by a network device, and the apparatus includes:
a determining module, configured to determine second synchronization signal block (SSB) configuration information based on first SSB configuration information and/or a first system message, where the second SSB configuration information includes configuration information of one or more second SSB transmission parameters; and a transmitting module, configured to transmit the first SSB configuration information and/or the first system message.

In an implementation, the second SSB configuration information includes at least one of the following:
a frequency domain resource of a second SSB;
a time domain resource of the second SSB; or
a beam for transmitting the second SSB.

In an implementation, the determining module is configured to:
determine an offset value relative to a baseline reference frequency domain position based on the first system message, and determine a frequency domain position of a second SSB based on the offset value.

In an implementation, the first system message includes a frequency domain position of the initial downlink bandwidth part (BWP) corresponding to the second SSB; and
the determining module is configured to:
determine a frequency domain position of the second SSB according to the frequency domain position of the initial downlink BWP.

In an implementation, the determining module is configured to:
determine a mapping relationship between partial transmission parameters of the second SSB and partial transmission parameters of the first SSB, and determine the partial transmission parameters of the second SSB based on transmission parameters of the first SSB and the mapping relationship.

In an implementation, the partial transmission parameters include at least one of the following:
a time domain position for transmitting the second SSB;
a transmission period of the second SSB;
a number of SSBs contained in one SSB burst for the second SSB; or
beam information used by the second SSB.

In an implementation, the mapping relationship includes the partial transmission parameters of the second SSB are same as the partial transmission parameters of the first SSB.

In an implementation, the determining module is further configured to:
determine based on the first system message, remaining transmission parameters except the partial transmission parameters determined based on the first SSB configuration information.

In an implementation, the determining module is configured to:
acquire an initial downlink BWP corresponding to a second SSB based on the first system message, acquire a second system message within the initial downlink BWP; and determining the second SSB configuration information based on the second system message.

According to a fifth aspect of an embodiment of the present disclosure, an information configuration apparatus is provided, including:
a processor; a memory for storing executable instructions for the processor; where the processor is configured to: perform the information configuration method described in the first aspect or any of implementations in the first aspect, or, perform the information configuration method described in the second aspect or any of implementations in the second aspect.

According to a sixth aspect of an embodiment of the present disclosure, a non-transitory computer-readable storage medium is provided, which, when instructions in the storage medium are executed by a processor of a mobile terminal, enables the mobile terminal to execute the information configuration method described in the first aspect or any of implementations in the first aspect, or enables the mobile terminal to execute the information configuration method described in the second aspect or any of implementations in the second aspect.

The technical solutions provided by embodiments of the present disclosure may include the following beneficial effects: a corresponding SSB can be configured for a terminal (for example, a RedCap terminal), and a way for the terminal to acquire corresponding SSB configuration information is further proposed, thus solving the problem of how to configure corresponding SSB transmission parameters for different types of terminals.

It can be further understood that “plurality” in the present disclosure means two or more, and that other quantifiers are similar. “And/or”, which describes the relationship of related objects, means that there can be three kinds of relationships, for example, A and/or B, which can mean that A exists alone, A and B exist together, and B exists alone. The character “/” generally indicates that the associated object is an “or” relationship. Singular forms of “a”, “said”, and “the” are also intended to include majority forms, unless the context clearly indicates otherwise.

It can be further understood that the terms “first”, “second”, etc. may be used to describe various information, but this information should not be limited to these terms. These terms are used only to distinguish the same type of information from one another and do not indicate a specific order or degree of importance. In fact, expressions such as “first” and “second” can be used interchangeably. For example, without departing from the scope of the present disclosure, first information can also be called second information, and similarly, the second information can also be called the first information.

It can be further understood that although the operations are described in a specific order in the accompanying drawings in the embodiments of the present disclosure, it should not be understood as requiring that these operations be performed in the specific order or serial order shown, or that all the operations shown should be performed to obtain the desired results. In certain circumstances, multitasking and parallel processing may be beneficial.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. An information configuration method, performed by a terminal, comprising:
acquiring at least one of first synchronization signal block (SSB) configuration information or a first system message; and
determining second SSB configuration information based on at least one of the first SSB configuration information or the first system message;
wherein the second SSB configuration information comprises configuration information of one or more second SSB transmission parameters.

2. The information configuration method according to claim 1, wherein the second SSB configuration information comprises at least one of:
a frequency domain resource of a second SSB;
a time domain resource of the second SSB; or
a beam for transmitting the second SSB.

3. The information configuration method according to claim 1, wherein determining the second SSB configuration information based on at least one of the first SSB configuration information or the first system message comprises:
determining an offset value relative to a baseline reference frequency domain position based on the first system message, and
determining a frequency domain position of a second SSB based on the offset value.

4. The information configuration method according to claim 1, wherein the first system message comprises a frequency domain position of an initial downlink bandwidth part (BWP) corresponding to a second SSB; and
determining the second SSB configuration information based on at least one of the first SSB configuration information or the first system message comprises:
determining a frequency domain position of the second SSB according to the frequency domain position of the initial downlink BWP.

5. The information configuration method according to claim 1, wherein determining the second SSB configuration information based on at least one of the first SSB configuration information or the first system message comprises:
determining a mapping relationship between partial transmission parameters of the second SSB and partial transmission parameters of the first SSB, and
determining the partial transmission parameters of the second SSB based on transmission parameters of the first SSB and the mapping relationship.

6. The information configuration method according to claim 5, wherein the partial transmission parameters of the second SSB comprises at least one of:
a time domain position for transmitting the second SSB;
a transmission period of the second SSB;
a number of SSBs contained in one SSB burst for the second SSB; or
beam information used by the second SSB.

7. The information configuration method according to claim 5, wherein the mapping relationship comprises the partial transmission parameters of the second SSB are same as the partial transmission parameters of the first SSB.

8. The information configuration method according to claim 7, wherein determining the second SSB configuration information based on at least one of the first SSB configuration information or the first system message further comprises:
determining, based on the first system message, remaining transmission parameters except the partial transmission parameters determined based on the first SSB configuration information.

9. The information configuration method according to claim 1, wherein determining the second SSB configuration information based on at least one of the first SSB configuration information or the first system message comprises:
acquiring an initial downlink bandwidth part (BWP) corresponding to a second SSB based on the first system message;
acquiring a second system message within the initial downlink BWP; and
determining the second SSB configuration information based on the second system message.

10. An information configuration method, performed by a network device, comprising:
determining second synchronization signal block (SSB) configuration information based on at least one of first SSB configuration information or a first system message, wherein the second SSB configuration information comprises configuration information of one or more second SSB transmission parameters; and
transmitting at least one of the first SSB configuration information or the first system message.

11. The information configuration method according to claim 10, wherein the second SSB configuration information comprises at least one of:
a frequency domain resource of a second SSB;
a time domain resource of the second SSB; or
a beam for transmitting the second SSB.

12. The information configuration method according to claim 10, wherein determining the second SSB configuration information based on at least one of the first SSB configuration information or the first system message comprises:
determining an offset value relative to a baseline reference frequency domain position based on the first system message, and
determining a frequency domain position of a second SSB based on the offset value.

13. The information configuration method according to claim 10, wherein the first system message comprises a frequency domain position of an initial downlink bandwidth part (BWP) corresponding to the second SSB; and
determining the second SSB configuration information based on at least one of the first SSB configuration information or the first system message comprises:
determining a frequency domain position of the second SSB according to the frequency domain position of the initial downlink BWP.

14. The information configuration method according to claim 10, wherein determining the second SSB configuration information based on at least one of the first SSB configuration information or the first system message comprises:
determining a mapping relationship between partial transmission parameters of the second SSB and partial transmission parameters of the first SSB, and
determining the partial transmission parameters of the second SSB based on transmission parameters of the first SSB and the mapping relationship;
wherein the mapping relationship comprises the partial transmission parameters of the second SSB are same as the partial transmission parameters of the first SSB.

15. The information configuration method according to claim 14, wherein the partial transmission parameters of the second SSB comprise at least one of:
a time domain position for transmitting the second SSB;
a transmission period of the second SSB;
a number of SSBs contained in one SSB burst for the second SSB; or
beam information used by the second SSB.

16. (canceled)

17. The information configuration method according to claim 14, wherein determining the second SSB configuration information based on at least one of the first SSB configuration information or the first system message further comprises:
determining, based on the first system message, remaining transmission parameters except the partial transmission parameters determined based on the first SSB configuration information.

18. The information configuration method according to claim 10, wherein determining the second SSB configuration information based on at least one of the first SSB configuration information or the first system message comprises:
acquiring an initial downlink bandwidth part (BWP) corresponding to a second SSB based on the first system message;
acquiring a second system message within the initial downlink BWP; and
determining the second SSB configuration information based on the second system message.

19-20. (canceled)

21. An information configuration apparatus, comprising:
a processor;
a memory, configured to store processor-executable instructions;
wherein the processor is configured to:
acquire at least one of first synchronization signal block (SSB) configuration information or a first system message; and
determine second SSB configuration information based on at least one of the first SSB configuration information or the first system message;
wherein the second SSB configuration information comprises configuration information of one or more second SSB transmission parameters.

22. A non-transitory computer-readable storage medium, which, when instructions in the storage medium are executed by a processor of a mobile terminal, enables the mobile terminal to execute the information configuration method according to claim 1.

23. An information configuration apparatus, comprising:
a processor;
a memory, configured to store processor-executable instructions;
wherein the processor is configured to execute the information configuration method according to claim 10.
